(19) United States
(12) Patent Application Publication
(10) Pub. No.: US 2021/0307424 A1
(43) Pub. Date: Oct. 7, 2021

(54) FILTERING FACE-PIECE RESPIRATOR

(71) Applicant: WELLSPAN HEALTH, York, PA (US)

(72) Inventor: Richard A. MAJKA, Marysville, PA (US)

(21) Appl. No.: 17/223,490

(22) Filed: Apr. 6, 2021

Related U.S. Application Data
(60) Provisional application No. 63/006,559, filed on Apr. 7, 2020.

(51) Int. Cl. A41D 13/11; A62B 23/02

(52) U.S. Cl. CPC A41D 13/1161; A41D 2400/52; A62B 23/025

(57) ABSTRACT

A filtering face-piece respirator or mask that includes a filtering face-piece respirator body and a harness. The filtering face-piece respirator body includes a filtering structure. The filtering face-piece respirator can be worn in an environment where there is risk of contamination to the wearer or to other persons or things, for example, in hospital or doctor's office.

### FIELD OF THE INVENTION

The present invention pertains to a filtering face-piece respirator or mask. In particular the invention is directed to a filtering face-piece respirator or mask which has a rigid fold to provide a space between the user's face and the mask.

### BACKGROUND OF THE INVENTION

Respirators are commonly worn over the breathing passages of a person for at least one of two common purposes: (1) to prevent impurities, contaminants or pathogens from entering the wearer's breathing track; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

A variety of respirators have been designed to meet either (or both) of these purposes. Some of these respirators have been categorized as being “filtering face-pieces” because the filtering body itself functions as the filtering mechanism. Unlike respirators that use rubber or elastomeric mask bodies in conjunction with attachable filter cartridges or insert-molded filter elements, filtering face-piece respirators have the filter media cover much of the whole filtering body so that there is no need for installing or replacing a filter cartridge. Conventional filtering face piece respirators have regularly comprised non-woven webs of thermally-bonding fibers or open-work plastic meshes to furnish the filtering body with its cup-shaped configuration. As such, filtering face-piece respirators are relatively light in weight and easy to use.

One such filtering face-piece is shown and described in U.S. Pat. No. 5,322,061. The filtering face-piece or disposable mask that includes a filter media capable of filtering particles of a size appropriate for its purposes, while providing breathability. The mask is formed from multiple layers of filtration material having the general configuration of a trapezoid. The mask includes an upper portion and a separate lower portion which are bonded together. As these disposable masks have distinct and separate upper and lower portions which must be joined, the manufacture of these masks is complicated and expensive.

It would, therefore, be beneficial to provide a filtering face-piece respirator which overcomes the problems associated with the know art. In addition, it would be beneficial to provide a filtering face-piece respirator in which each layer of the body is made from one piece, thereby allowing the filtering face-piece respirator to be quickly and efficiently manufactured.

### SUMMARY OF THE INVENTION

An embodiment is directed to a disposable filtering face-piece respirator or mask which can worn in an environment where there is risk of contamination to the wearer or to other persons or things, for example, in hospital or doctor's office. The disposable filtering face-piece respirator or mask has a rigid fold which maintains space between the wearer's face and the body of the disposable filtering face-piece respirator or mask.

An embodiment is directed to a disposable filtering face-piece respirator which can be worn by a wearer in an environment where there is risk of contamination to the wearer or other persons. The disposable filtering face-piece respirator includes a filtering body which has an inside layer proximal to a face of the wearer, and an outside layer extending from the inside layer in a direction away from the face of the wearer. The inside layer is made from a first single piece of material and the outside layer is made from a second single piece of material. The inside layer is attached to the outside layer around the edges of the inside layer and the outside layer. A rigid fold is provided the inside layer and the outside layer. The rigid fold is provided between a top edge of the filtering body and a bottom edge of the filtering body. The rigid fold has material of the inside layer and the outside layer which has been heated and cooled. Support members extend from the filtering body and are configured to engage the head of the wearer to properly position the filtering body of the mask on the face of the wearer. The rigid fold maintains the structure of the filtering body to keep a midportion of the filtering body away from the face of the wearer and the edges of the filtering body in contact with the face of the wearer.

An embodiment is directed to a disposable filtering face-piece respirator which can be worn by a wearer in an environment where there is risk of contamination to the wearer or other persons. The disposable filtering face-piece respirator includes a filtering body which has an inside layer proximal to a face of the wearer, and an outside layer extending from the inside layer in a direction away from the face of the wearer. The inside layer is made from a first single piece of material and the outside layer is made from a second single piece of material. The inside layer is attached to the outside layer around the edges of the inside layer and the outside layer. A rigid fold is provided the inside layer and the outside layer. The rigid fold is provided between a top edge of the filtering body and a bottom edge of the filtering body and extends from proximate intersections of the top edge and the bottom edge. The rigid fold has material of the inside layer and the outside layer which has been heated and cooled. The rigid fold has a first side portion, a center portion and a second side portion. The first side portion and the second side portion extend from proximate the intersections of the top edge and the bottom edge. The rigid fold extends at an obtuse angle relative to the first side portion and the second side portion. Support members extend from the filtering body and are configured to engage the head of the wearer to properly position the filtering body of the mask on the face of the wearer. The rigid fold maintains the structure of the filtering body to keep a midportion of the filtering body away from the face of the wearer and the edges of the filtering body in contact with the face of the wearer.

Other features and advantages of the present invention will be apparent from the following more detailed description of the illustrative embodiment, taken in conjunction with the accompanying drawings which illustrate, by way of example, the principles of the invention.

### BRIEF DESCRIPTION OF THE DRAWINGS

FIG. 1 is a plan view of an illustrative filtering face-piece respirator of the invention.

FIG. 2 is a side view of the filtering face-piece respirator of FIG. 1 positioned on a user's head.

FIG. 3 is a front perspective of the filtering face-piece respirator of FIG. 1.

FIG. 4 is a back perspective of the filtering face-piece respirator of FIG. 1.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

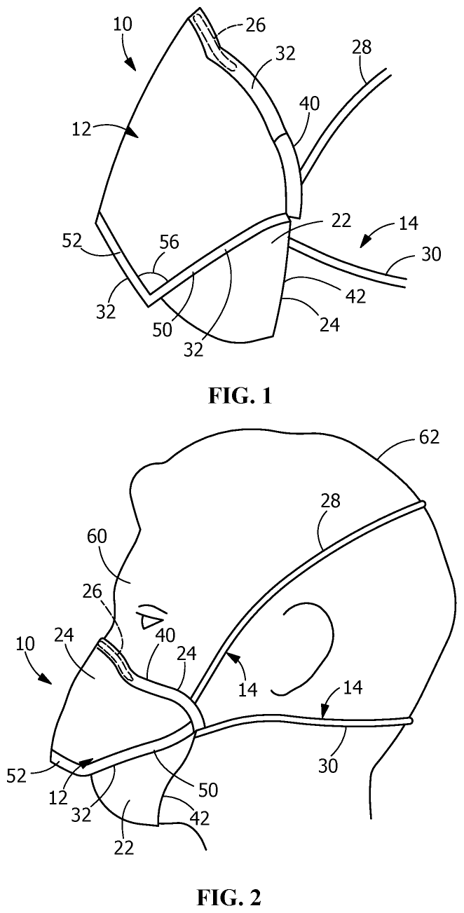

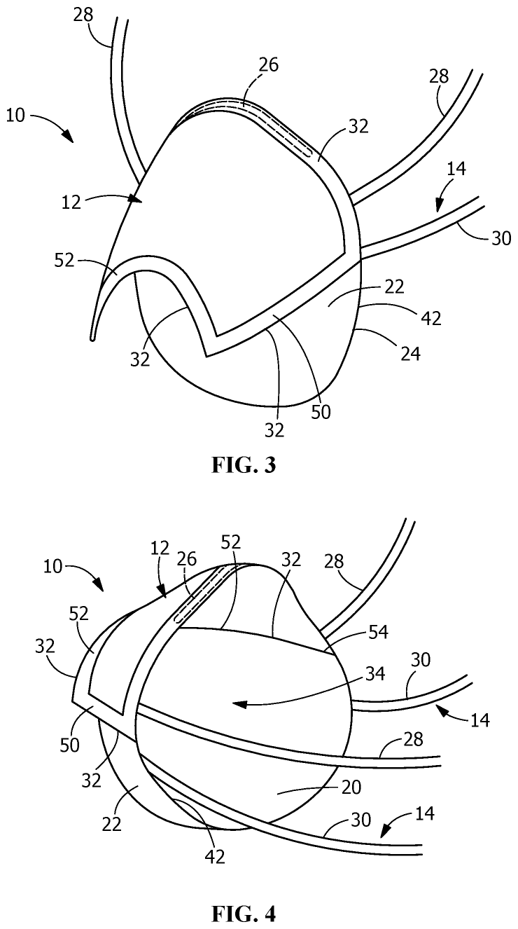

FIGS. 1 and 2 show an example of a disposable filtering face-piece respirator or mask 10 that may be used in accordance with the present invention to provide clean air for the wearer to breathe. As illustrated, the filtering face-piece respirator 10 includes a filtering body 12 and a support member or harness 14. The filtering body 12 is a filtering structure which removes contaminants from the ambient air when the wearer inhales. The filtering face-piece respirator or mask 10 is generally sized to fit over the nose and mouth of a wearer.

The filtering body 12 includes an inside surface or layer 20 (FIG. 4), i.e., the layer proximal to the face of the wearer, and an outside surface or layer 22, i.e., the layer distal to the face of the wearer. The inside layer 20 is made from a first single piece of material and the outside layer 22 is made from a second single piece of material. The material of the inside layer 20 and the outside layer 22 may be the same or different, as will be discussed. The inside layer 20 is attached to the outside layer 22 around a periphery 24 of the filtering body 12 and the inside layer 20 and the outside layer 22. The inside layer 20 may be attached to the outside layer 22 by stitching, adhesive or other know methods.

The filtering body 12 includes a periphery 24 that is adapted to engage the face of the wearer when the mask is donned. The periphery includes a top edge 40 and a bottom edge 42.

A malleable nose clip 26 is positioned proximate the top edge 40 and extends across the bridge of the wearers nose in the cross-wise dimension. The nose clip 26 may be made from aluminum and is maintained on the filtering body 12 by adhesive or other known means. The nose clip 26 is visibly exposed so that the wearer can see the clip to know of its presence and so that it can be properly deformed into a desired shape or configuration so that the mask 10 snugly fits the wearer over the bridge of the nose and against the face beneath the eyes. Typically, the wearer's face will contact only the periphery 24 of the filtering body 12, as will be more fully described.

The respirator or mask 10 can be supported on a face 60 of a wearer 62 by the support member 14. In the illustrative embodiment shown, the support member 14 includes first strap 28 and a second strap 30. The straps 28, 30 may be resilient and elastic and may be attached to the filtering body 12 by heat welding or other known methods. The straps 28, 30 may fixed in length or may be adjustable in length by known methods. However, other types of support members 14 may be used.

The filtering body 12 includes a rigid fold 32 which extends through the inside layer 20 and the outside layer 22. The rigid fold 32 is provided between the 40 top edge of the filtering body 12 and the bottom edge 42 of the filtering body 12, and extends from proximate the intersections 44 of the top edge 40 and the bottom edge 42. The rigid fold 32 has material of the inside layer 20 and the outside layer 22 which has been heated and cooled to bond the layers of the rigid fold 32 together to provide strength and rigidity. The rigid fold 32 has a first side portion 50, a center portion 52 and a second side portion 54. The first side portion 50 and the second side portion 54 extend from proximate the intersections 44 of the top edge 40 and the bottom edge 44 of the filtering body 12 to the center portion 52 of the rigid fold 32. In the illustrative embodiment shown, the rigid fold 32 extends at an obtuse angle 56 relative to the first side portion 50 and the second side portion 54.

The rigid fold 32 allows the filtering body 12 to be maintained in a position in which the inside layer 20 forms a cavity 34, thereby allowing the inside layer 20 to be spaced from the users face 60 except at the periphery 24 of the main body 12. The rigid fold is heat welded to allow the plastic material in the inside layer 20 and the outside layer 22 to melt and then cool to form the rigid fold 32 to allow the filtering body 12 to retain its shape during use and over time.

The present invention allows optimizing the barrier formed between the periphery 24 of the filtering body 12 and the face 60 of wearer 62 and the filtration capability of the filtering body 12 to resist the passage of particular matter and aerosols through inner layer 20 and the outer layer 22 of the filtering body 12 while minimizing resistance to normal breathing of the wearer 62 resulting from the use of the respirator or mask 10.

The present invention allows the respirator or mask 10 to provide “off-the-face” benefits of a molded-cone style mask. “Off-the-face” style masks provide a larger breathing chamber as compared to soft, pleated masks which contact a substantial portion of the wearer's face. Therefore, “off-the-face” masks permit cooler and easier breathing. The present invention also allows optimizing the volume of air contained within the cavity 34 of the filtering body 12. If the volume is too large, excessive amounts of exhaled air may be retained within the filtering body 12 at normal breathing rates. By properly selecting the size of filtering body 12, excessive heating of the air within the cavity 34 of the filtering body 12 is minimized and dizziness from prolonged periods of rebreathing exhaled air is minimized.

The filtering body 12 of the mask 10 of the present invention may be formed from a variety of materials and fabrics, such as woven reusable fabrics and nonwoven disposable fabrics or webs. As used herein, the term “nonwoven fabric” or “nonwoven web” or “nonwoven material” means a web having a structure of individual fibers or threads that are randomly interlaid, but not in an identifiable manner or pattern as in a knitted fabric. Nonwoven fabrics or webs have been formed from many processes, for example, melt blowing processes, spunbonding processes, and bonded carded web processes.

As used herein, the term “spunbond” or “spunbond fibers” or “spunbonded fibers” refers to small diameter fibers that are formed by extruding molten thermoplastic material as filaments from a plurality of fine, usually circular capillaries of a spinneret with the diameter of the extruded filaments then being rapidly reduced.

As used herein, the term “melt blown” or “melt blown fibers” means fibers formed by extruding a molten thermoplastic material through a plurality of fine, usually circular, die capillaries as molten threads or filaments into converging high velocity, usually hot, gas (e.g., air) streams that attenuate the filaments of molten thermoplastic material to reduce their diameter, which may be to microfiber diameter. Thereafter, the melt blown fibers are carried by the high velocity gas stream and are deposited on a collecting surface to form a web of randomly disbursed melt blown fibers.

In alternate embodiments, the filtering body 12 of the mask 10 may be formed from a single layer of material or a composite of multiple layers. In the case of multiple layers, the layers are generally positioned in a juxtaposed or surface-to-surface relationship and all or a portion of the layers may be bound to adjacent layers. The multiple layers of a composite may be joined to form a multilayer laminate by various methods, including but not limited to adhesive bonding, thermal bonding, or ultrasonic bonding.

One composite material suitable for use with the present invention is a melt blown polypropylene/spunbond polyester material. In this composite, the melt blown polypropylene is the outside layer 22 and the spunbond polyester is the inside layer 20. Alternatively, the fabric layers may be made individually, collected in rolls, and combined in a separate bonding step. Multilayer laminates may have multiple melt blown layers or multiple spunbond layers in many different configurations and may include materials other than nonwovens.

The face mask of the present invention includes a layer of material, for example, a nonwoven material, suitable for filtration. The filtration material may be made from a melt blown nonwoven web and, in some embodiments, may be subject to electret treating. As used herein, the term “electret” or “electret treating” refers to a treatment that imparts a charge to a dielectric material, such as a polyolefin. The charge includes layers of positive or negative charges trapped at or near the surface of the polymer, or charge clouds stored in the bulk of the polymer. The charge also includes polarization charges that are frozen in alignment of the dipoles of the molecules. Methods of subjecting a material to electret treating are well known by those skilled in the art. These methods include, for example, thermal, liquid-contact, electron beam, and corona discharge methods. Electret treatment results in a charge being applied to the filtration medium that further increases filtration efficiency by drawing particles to be filtered toward the filter by virtue of their electrical charge. Electret treatment can be carried out by a number of different techniques.

The minimum filtration efficiency requirements differ for various applications. The filtration layer may also be required to attain a desired bacterial filtration efficiency (BFE). The BFE is a measure of the ability of a material to prevent the passage of bacteria through it. Face masks for medical applications may require a BFE of greater than or equal to about 95% for particles of 0.3 microns.

An exhalation valve (not shown) may be attached to the filtering body to facilitate purging exhaled air from the interior gas space. The use of an exhalation valve may improve wearer comfort by rapidly removing the warm moist exhaled air from the mask interior. Essentially any exhalation valve that provides a suitable pressure drop and that can be properly secured to the filtering body may be used in connection with the present invention to rapidly deliver exhaled air from the interior gas space to the exterior gas space.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A disposable filtering face-piece respirator which can be worn by a wearer in an environment where there is risk of contamination to the wearer or other persons, the disposable filtering face-piece respirator comprising:
a filtering body having an inside layer proximal to a face of the wearer, and an outside layer extending from the inside layer in a direction away from the face of the wearer, the inside layer being made from a first single piece of material and the outside layer being made from a second single piece of material, the inside layer being attached to the outside layer around a periphery of the inside layer and the outside layer;
a rigid fold in the inside layer and the outside layer, the rigid fold being provided between a top edge of the filtering body and a bottom edge of the filtering body, the rigid fold having material of the inside layer and the outside layer which has been heated and cooled;
support members extending from the filtering body, the support members configured to engage a head of the wearer to properly position the filtering body of the mask on the face of the wearer;
wherein the rigid fold maintains the structure of the filtering body to keep a midportion of the filtering body away from the face of the wearer and the periphery of the filtering body in contact with the face of the wearer.

2. The disposable filtering face-piece respirator as recited in claim 1, wherein the periphery of the inside layer and the outside layer engage a face of the wearer when the mask is donned, the periphery includes a top edge and a bottom edge, the periphery is the only portion of the filtering body that contacts the face of the wearer.

3. The disposable filtering face-piece respirator as recited in claim 2, wherein a malleable nose clip is positioned proximate the top edge and extends across a bridge of the wearer's nose in the cross-wise dimension.

4. The disposable filtering face-piece respirator as recited in claim 2, wherein the rigid fold extends from proximate intersections of the top edge and the bottom edge.

5. The disposable filtering face-piece respirator as recited in claim 4, wherein the rigid fold has material of the inside layer and the outside layer which has been heated and cooled to bond layers of the rigid fold together to provide strength and rigidity.

6. The disposable filtering face-piece respirator as recited in claim 5, wherein the rigid fold has a first side portion, a center portion and a second side portion, the first side portion and the second side portion extend from proximate the intersections of the top edge and the bottom to the center portion.

7. The disposable filtering face-piece respirator as recited in claim 6, wherein the rigid fold extends at an obtuse angle relative to the first side portion and the second side portion.

8. The disposable filtering face-piece respirator as recited in claim 2, wherein the rigid fold causes the inside layer to be spaced from the face of the wearer except at the periphery, the rigid fold forming a cavity to keep the midportion of the filtering body away from the face of the wearer.

9. The disposable filtering face-piece respirator as recited in claim 8, wherein the rigid fold is configured to optimize the volume of air contained within the cavity of the filtering body.

10. The disposable filtering face-piece respirator as recited in claim 1, wherein the support member includes a first strap and a second strap, the first strap and the second strap are connected to the filtering body, the first strap and the second strap are resilient and elastic.

11. A disposable filtering face-piece respirator which can be worn by a wearer in an environment where there is risk of contamination to risk to the wearer or other persons, the disposable filtering face-piece respirator comprising:
a filtering body having an inside layer proximal to a face of the wearer, and an outside layer extending from the inside layer in a direction away from the face of the wearer, the inside layer being made from a first single piece of material and the outside layer being made from a second single piece of material, the inside layer being attached to the outside layer around a periphery of the inside layer and the outside layer;
a rigid fold in the inside layer and the outside layer, the rigid fold being provided between a top edge of the filtering body and a bottom edge of the filtering body, the rigid fold extending from proximate intersections of the top edge and the bottom edge, the rigid fold having material of the inside layer and the outside layer which has been heated and cooled, the rigid fold having a first side portion, a center portion and a second side portion, the first side portion and the second side portion extend from proximate the intersections of the top edge and the bottom edge to the center portion of the rigid fold, the rigid fold extends at an obtuse angle relative to the first side portion and the second side portion;
support members extending from the filtering body, the support members configured to engage a head of the wearer to properly position the filtering body of the mask on the face of the wearer;
wherein the rigid fold maintains the structure of the filtering body to keep a midportion of the filtering body away from the face of the wearer and the periphery of the filtering body in contact with the face of the wearer.

12. The disposable filtering face-piece respirator as recited in claim 11, wherein the rigid fold causes the inside layer to be spaced from the face of the wearer except at the periphery, the rigid fold forming a cavity to keep the midportion of the filtering body away from the face of the wearer.

13. The disposable filtering face-piece respirator as recited in claim 12, wherein the periphery of the inside layer and the outside layer engage a face of the wearer when the mask is donned, the periphery is the only portion of the filtering body that contacts the face of the wearer.

14. The disposable filtering face-piece respirator as recited in claim 13, wherein the rigid fold extends from proximate intersections of the top edge and the bottom edge.

15. The disposable filtering face-piece respirator as recited in claim 14, wherein the rigid fold is configured to optimize the volume of air contained within the cavity of the filtering body.

16. The disposable filtering face-piece respirator as recited in claim 15, wherein a malleable nose clip is positioned proximate the top edge and extends across a bridge of the wearer's nose in the cross-wise dimension.

17. The disposable filtering face-piece respirator as recited in claim 16, wherein the support member includes a first strap and a second strap, the first strap and the second strap are connected to the filtering body, the first strap and the second strap are resilient and elastic.
